(19) United States
(12) Patent Application Publication
(10) Pub. No.: US 2022/0351568 A1
(43) Pub. Date: Nov. 3, 2022

(54) System and Method for Placing and Monitoring Bets

(71) Applicant: Nathan Kyam Smith, Phoenix, AZ (US)

(72) Inventor: Nathan Kyam Smith, Phoenix, AZ (US)

(21) Appl. No.: 17/661,290

(22) Filed: Apr. 29, 2022

Related U.S. Application Data
(60) Provisional application No. 63/182,202, filed on Apr. 30, 2021.

(51) Int. Cl. G07F 17/32; G06Q 50/34

(52) U.S. Cl. CPC G07F 17/323; G07F 17/3288; G06Q 50/34

(57) ABSTRACT

The present invention is a system and method for placing and monitoring bets, which provides a solution to the problem of monitoring games for favorable betting conditions. The core components of the invention are a device configured to receive event information, bet information, bets, bet conditions, monitor events, and place bets when betting conditions are met.

### CROSS-REFERENCE TO RELATED APPLICATION

This application claims the benefit of U.S. Provisional Patent Application No. 63/182,202, filed Apr. 30, 2021 which is incorporated by reference herein in its entirety.

### BACKGROUND

Many types of bets may be placed on events such as sporting events. Many entities allow bets to be placed during an ongoing event. The odds and other conditions of these bets often change during the event. Some gamblers monitor betting conditions for events in an attempt to place bets when odds are more favorable to their desired position. However, since odds are constantly updated and often updated after every play or live based on current betting trends, placing a bet with the desired conditions is difficult to manage with current systems that require bets to be placed individually in real time.

Further, it is impossible for a person to effectively monitor conditions of more than a handful of events happening at the same time. Thus, a gambler may miss an opportunity to place a favorable bet because his or her attention was directed to another event at the time.

### SUMMARY

The disclosed device is unique when compared with other known devices and solutions because it provides a system and method for a user to preselect conditions for a bet. The system monitors the event for the preselected conditions and places a bet for the user if and when the conditions are met.

The system has several advantages over existing systems in that it allows the user to place conditions for placing bets before the conditions are met. This allows a user to prepare for a time when many events are occurring at the same time. For example, in American Football, many games are often played concurrently on Sunday morning and afternoon. Using the disclosed system, a user could set up conditions for bets to be placed on many or all of the games such that the user can have the system monitor each of the games (something that would be impossible for the user to do on his or her own) and place bets when those conditions are met (at speeds that would not be possible for a person to accomplish).

### BRIEF DESCRIPTION OF DRAWINGS

FIG. 1 shows an example schematic view of a system.

FIG. 2 shows an example first flowchart of operations performed by a second device.

FIG. 3 shows an example second flowchart of operations performed by the second device.

FIG. 4 shows an example third flowchart of operations performed by the second device.

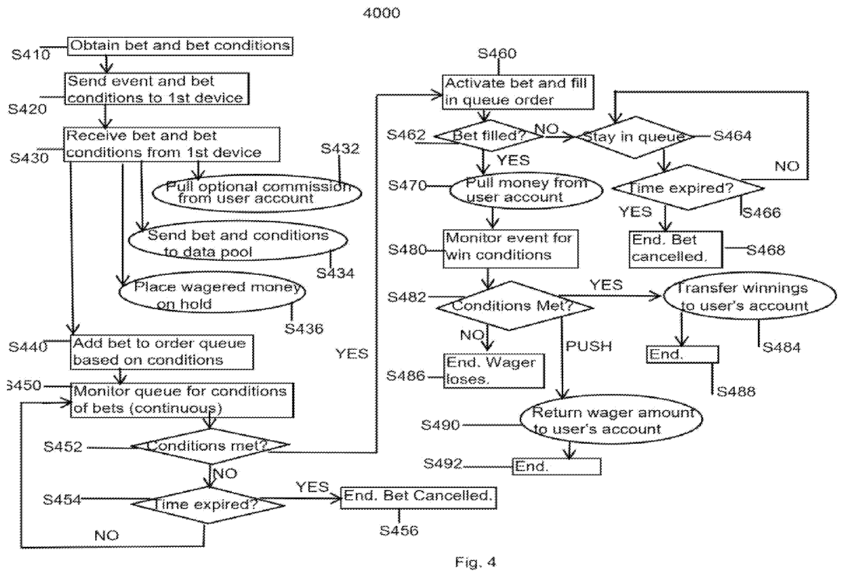

FIG. 5 shows an example view of a display of the first device.

### DETAILED DESCRIPTION

In the Summary above, in this Detailed Description, the claims below, and in the accompanying drawings, reference is made to particular features of the invention. It is to be understood that the disclosure of the invention in this specification includes all possible combinations of such particular features. For example, where a particular feature is disclosed in the context of a particular aspect or embodiment of the invention, or a particular claim, that feature can also be used—to the extent possible—in combination with and/or in the context of other particular aspects and embodiments of the invention, and in the invention generally.

The term “comprises” and grammatical equivalents thereof are used herein to mean that other components, ingredients, steps, etc. are optionally present. For example, an article “comprising” (or “which comprises”) components A, B, and C can consist of (i.e., contain only) components A, B, and C, or can contain not only components A, B, and C but also contain one or more other components.

Where reference is made herein to a method comprising two or more defined steps, the defined steps can be carried out in any order or simultaneously (except where the context excludes that possibility), and the method can include one or more other steps which are carried out before any of the defined steps, between two of the defined steps, or after all the defined steps (except where the context excludes that possibility).

The term “at least” followed by a number is used herein to denote the start of a range including that number (which may be a range having an upper limit or no upper limit, depending on the variable being defined). For example, “at least 1” means 1 or more than 1. The term “at most” followed by a number is used herein to denote the end of a range, including that number (which may be a range having 1 or 0 as its lower limit, or a range having no lower limit, depending upon the variable being defined). For example, “at most 4” means 4 or less than 4, and “at most 40%” means 40% or less than 40%. When, in this specification, a range is given as “(a first number) to (a second number)” or “(a first number)-(a second number),” this means a range whose limits include both numbers. For example, “25 to 100” means a range whose lower limit is 25 and upper limit is 100 and includes both 25 and 100.

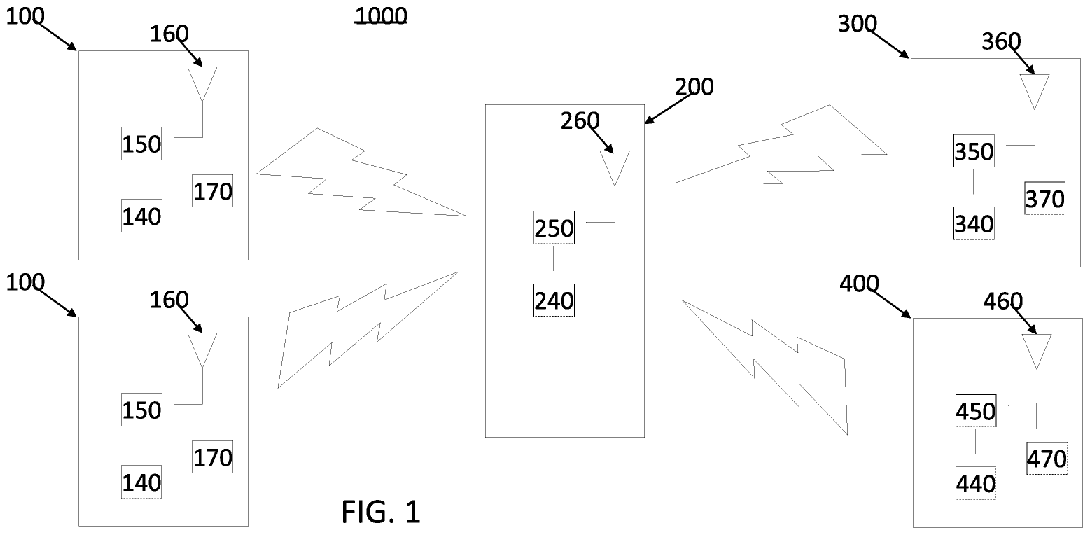

FIG. 1 shows an example schematic view of a system 1000. The system 1000 may include first devices 100, at least one second device 200, at least one third device 300 and at least one fourth device 400. The first devices 100 may be user devices through which users interact with the system 1000. For example, the first devices 100 may include laptop computers, desktop computers, mobile phones, tablets, and other consumer electronic devices. The first electronic device may include a memory 140, a processor 150, and a transceiver 160. The memory 140 may include volatile and non-volatile memory. The memory 140 may contain therein instruction for operating the first electronic device and other stored information. The memory 140 may be a non-transitory readable medium holding instructions thereon for implementing the features described below as part of an application, program, or other implementation of electronic instructions using electronic devices. The processor 150 may include one or more processing devices such as a central processing unit, controller, or other similar hardware. The processor 150 may be configured to execute the instructions stored in the memory 140 and control the first electronic device 100. The transceiver 160 may include one or more communication interfaces for wireless communications, wired communications, fiber optic communications, etc. The transceiver 160 may operate based on commands received from the processor 150 and be configured to communicate electronically with other electronic devices in the system 1000. The first electronic device 100 may also include a display 170. The display 170 may be configured to display images and information for a user based on commands received from the processor 150. The display 170 may be a touch screen capable of receiving input from a user.

The second electronic device 200 may be a host device for an application or program. The second electronic device 200 may include one or more computers, servers, or other similar devices. The second electronic device may include a memory 240, a processor 250, and a transceiver 260. The memory 240 may include volatile and non-volatile memory. The memory 240 may contain therein instructions for operating the second electronic device, operating a software platform, and other stored information. The memory 240 may be a non-transitory readable medium holding instructions thereon for implementing the features described below as part of an application, program, or other implementation of electronic instructions using electronic devices. The processor 250 may include one or more processing devices such as a central processing unit, controller, or other similar hardware. The processor 250 may be configured to execute the instructions stored in the memory 240 and control the second electronic device 200. The transceiver 260 may include one or more communication interfaces for wireless communications, wired communications, fiber optic communications, etc. The transceiver 260 may operate based on commands received from the processor 250 and be configured to communicate electronically with other electronic devices in the system 1000.

The third device 300 may be an event information device (e.g., a device that connects and disseminates information about events such as sporting events). The third device 300 may include at least one laptop computer, desktop computer, mobile phone, tablet, other consumer electronic device, server, and or other electronic device capable of collecting and transmitting information. The third electronic device 300 may include a memory 340, a processor 350, and a transceiver 360. The memory 340 may include volatile and non-volatile memory. The memory 340 may contain therein instruction for operating the third electronic device 300 and other stored information. The memory 340 may be a non-transitory readable medium holding instructions thereon for implementing the features described below as part of an application, program, or other implementation of electronic instructions using electronic devices. The processor 350 may include one or more processing devices such as a central processing unit, controller, or other similar hardware. The processor 350 may be configured to execute the instructions stored in the memory 340 and control the third electronic device 300. The transceiver 360 may include one or more communication interfaces for wireless communications, wired communications, fiber optic communications, etc. The transceiver 360 may operate based on commands received from the processor 350 and be configured to communicate electronically with other electronic devices in the system 1000. The third electronic device 300 may also include a display 370. The display 370 may be configured to display images and information based on commands received from the processor 350. The display 370 may be a touch screen capable of receiving input from a user.

The fourth device 400 may be a bookmaking device (e.g., a device used to create and maintain a book of bets, rates, and other similar information for gambling). The fourth device 400 may include at least one laptop computer, desktop computer, mobile phone, tablet, other consumer electronic device, server, and or other electronic device capable of collecting and transmitting information. The fourth electronic device 400 may include a memory 440, a processor 450, and a transceiver 460. The memory 440 may include volatile and non-volatile memory. The memory 440 may contain therein instruction for operating the fourth electronic device 400 and other stored information. The memory 440 may be a non-transitory readable medium holding instructions thereon for implementing the features described below as part of an application, program, or other implementation of electronic instructions using electronic devices. The processor 450 may include one or more processing devices such as a central processing unit, controller, or other similar hardware. The processor 450 may be configured to execute the instructions stored in the memory 440 and control the fourth electronic device 400. The transceiver 460 may include one or more communication interfaces for wireless communications, wired communications, fiber optic communications, etc. The transceiver 460 may operate based on commands received from the processor 450 and be configured to communicate electronically with other electronic devices in the system 1000. The fourth electronic device 400 may also include a display 470. The display 470 may be configured to display images and information based on commands received from the processor 450. The display 470 may be a touch screen capable of receiving input from a user.

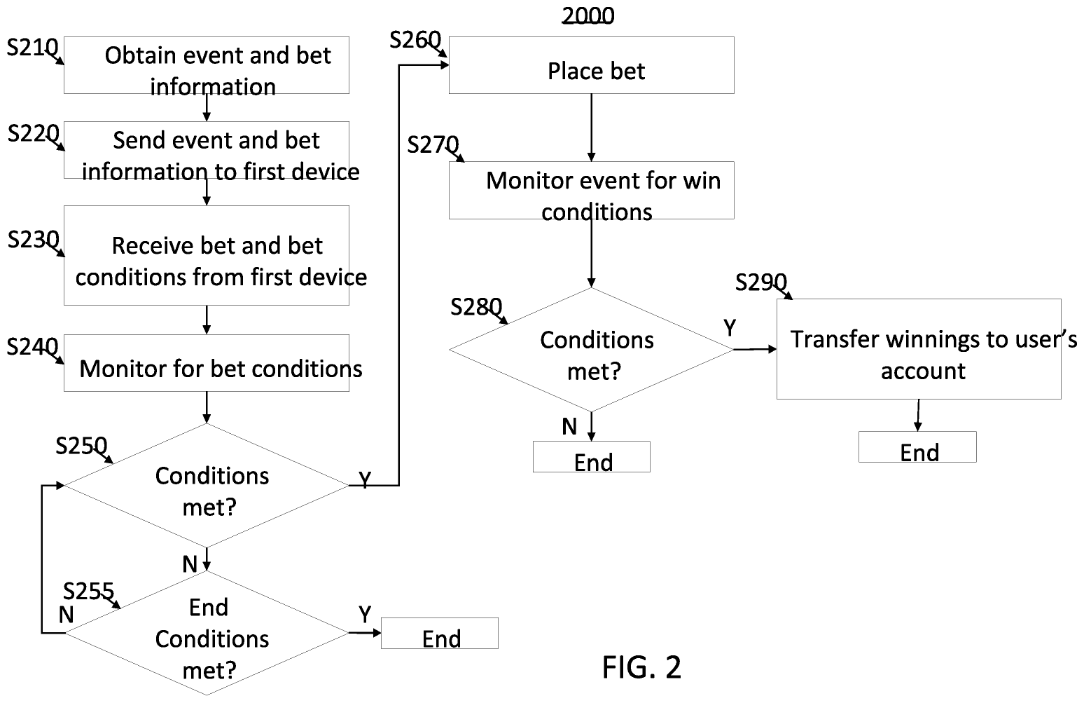

FIG. 2 shows an example first flowchart of operations performed by the second device 200. At S210, the second device 200 may obtain event information and bet information. The event information may include event dates and times, participants (such as names of sports teams competing in an event), statistics for teams and players or other participants in the event, weather or other condition information for the event, and other information related to the events. The bet information may include current odds, spread, predicted game total, minimum and maximum bets, and other information related to placing bets on events. Second device 200 may obtain the event information from the third device 300 or the fourth device 400. For example, the fourth device may communicate with the third device 300 to receive event information from the third device 300 and the fourth device 400 may generate the bet information based on the event information and transmit both the bet information and the event information to the second device 200. As another example, the second device 200 may communicate with the third device 300 to obtain the event information.

The second device 200 may generate all of the bet information based on the event information. Alternatively, the second device 200 may generate a portion of the bet information and may receive a portion of the bet information from the fourth device. For example, the second device 200 may generate its own odds for bets on an event but may factor into the generation of those odds the rates offered by other bookmakers. As another alternative, the second device 200 may receive all of the bet information from the fourth device 400. For example, the second device may not determine any rates, odds, or other information but may be programmed to place bets on other bookmaker's books by communicating with the fourth device 400.

At S220, the second device 200 may send the event and bet information to at least one of the first devices 100. The first device 100 may receive the bet information and the event information and display the bet information and the event information to users.

At S230, the second device 200 may receive at least one bet and at least one bet condition from the first device 100. For example, a bet may be $250 on the Bears to beat the Tigers on Jul. 17, 2021. The bet conditions may include making the bet only if the spread is Bears +5, the odds are +200 and it is before the end of the first quarter. In this way, the first device (based on information from the user) may define and transmit a bet and bet conditions. The information included in the bet may be an event and a bet amount. The information included in the bet condition(s) may include timing conditions (at what point in an event the bet may be placed), odds (including odds range), spread (including spread range), game total requirements, actual current game total (e.g., current score when bet is placed) as well as other conditions.

At S240, the second device 200 may monitor for the bet conditions. The second device 200 may receive event information (current time, score, statistics, etc. for the event) from the third device 300 or the fourth device 400. The second device 200 may also receive bet information (current odds, spread, etc.) from the fourth device 400 and/or generate the bet information. The second device 200 may monitor this information so a determination can be made as to whether the bet conditions have been met.

At S250, the second device 200 may determine if the bet conditions have been met. For example in the example given above, the second device 200 may check the event information and bet information to determine if each of the following are true: is spread at least Bears +5?; are odds at least +200?; and is it before the end of the first quarter in the event? If each of the bet conditions have been met, the second device 200 may proceed to S260. If at least one of the bet conditions have not been met, the second device 200 may proceed to S255.

At S255, the second device 200 may determine if an end condition has been met. An end condition may be a condition that can never be true, or the end of the event, or other similar condition that makes it so the bet will not be placed. For example, in the example given above, if the event is in the second quarter (e.g., the first quarter has ended) then the bet will never be placed and an end condition has been met. If an end condition has been met, the process may end. Alternatively, the second device 200 may send a message to the first device 100 that an end condition has been met and then end. If an end condition has not been met, the second device 200 may return to S250 and at the next time the event information or bet information is updated may again check to see if the bet conditions have been met.

At 260, the second device 200 may place the bet. The bet may be placed (e.g., recorded) in the second device 200 (if the second device 200 has bookmaking capability) or may be conveyed to the fourth device 400.

At 270, the second device 200 may monitor the event for win conditions. The second device 200 may receive event information from the third device or the fourth device that may be used to determine if the win conditions of the bet have been met.

At S280, the second device 200 may determine if the win conditions have been met. The win conditions may be part of the bet that is used to determine if the bet has won. For example, in the example given above, the second device 200 may determine if the Bears lose the game by less than 5 points. If the win conditions are met, the second device 200 may proceed to S290. If the win conditions are not met, the second device 200 may end the process, or alternatively send a message to the first device 100 indicating that the bet was not successful.

At S290, the second device 200 may transfer winnings to a user's account. The winnings are determined by the bet. For example, in the example given above, the winnings for a bet of $250 with odds of +200 would be $500. A bookmaking fee, service fee, or other fees may be taken out of the winnings. The user account may be a digital wallet, bank account, or other way of holding monetary assets. For example, the second device 200 may place the winnings in a digital wallet hosted by the second device 200 or may communicate with a bank device (not shown) to transfer funds to a bank account of the user. In some embodiments, the second device 200 may communicate with other devices such as the fourth device 400 (for example, if the bet is placed on the books of the fourth device 400) to cause the funds to be transferred to the user's account. After the winnings are distributed the process may end.

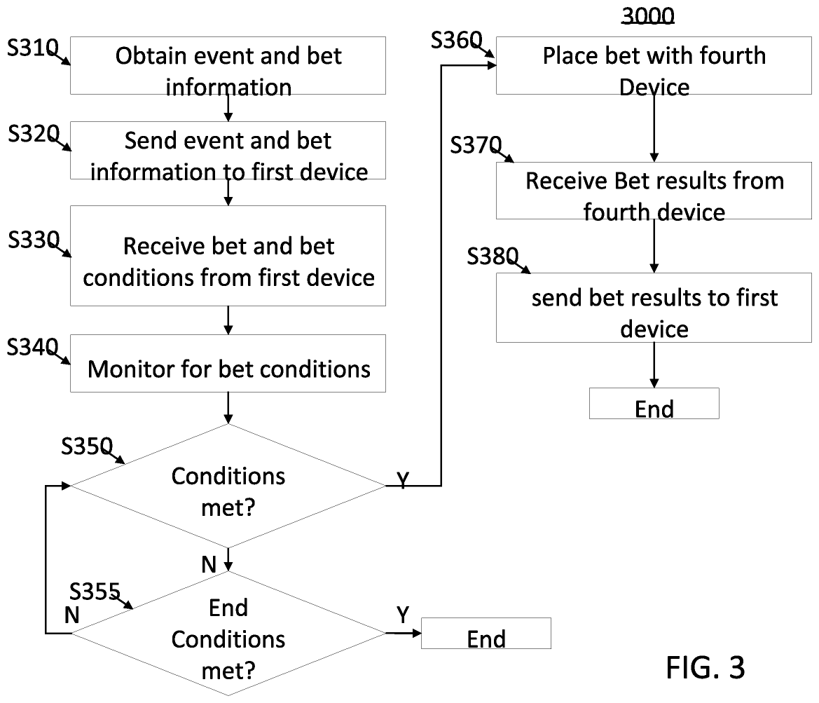

FIG. 3 shows an example second flowchart 3000 of operations performed by the second device 200. The second flowchart 3000 is for embodiments where the second device 200 does not provide bookmaking services and communicates with the fourth device 400 for bookmaking to be done on the fourth device 400. At S310, similarly to S210 from the first flowchart 2000, the second device 200 may obtain event and bet information. The event information and bet information may be obtained by communicating with third device 300 and/or the fourth device 400.

At S320, similarly to S220, the second device 200 may send the bet information and the event information to the first device 100. At S330, similarly to S230, the second device 200 may receive the bet and bet conditions from the first device 100. At S340, similarly to S240, the second device 200 may monitor for bet conditions. The second device may receive the bet information and event information by communicating with the third device 300 and/or the fourth device 400 and monitor the bet information and event information to be able to determine if the bet conditions have been met.

At S350, similarly to S250, the second device 200 may determine if the bet conditions have been met. If each of the bet conditions have been met, the second device 200 may proceed to S360. If at least one of the bet conditions have not been met, the second device 200 may proceed to S355. [0032] At S355, similarly to S255, the second device 200 may determine if an end condition has been met. If an end condition has been met the process may end. Alternatively, the second device 200 may send a message to the first device 100 that an end condition has been met and then end. If an end condition has not been met, the second device 200 may return to S350 and at the next time the event information or bet information is updated may again check to see if the bet conditions have been met.

At S360, the second device 200 may place a bet with the fourth device 400. The bet may be placed by sending a request or command to the fourth device 400 to place the bet. The fourth device 400 may monitor for win conditions and communicate results to the second device 200. At S370, the second device 200 may receive bet results from the fourth device 400. The bet results may be an indication of a win or loss and may include final statistics and other information pertinent to understanding the result. At S380, the second device 200 may transmit the bet results to the first device 100.

Several alternative embodiments may also exist beyond those described above. For example, the second device may display information and receive information directly from a user (e.g., communications with the first devices would be unnecessary because the user is directly communicating with the second device). As another example, the third and fourth devices 300, 400 may be the same device included in the same set of devices.

The third flowchart 4000 is for embodiments wherein the second device 200 includes a conditional wager queue wherein bet conditions are placed in chronological order. In this embodiment, the second device may provide bookmaking services. At S410, similarly to S210 from the first flowchart 2000, the second device 200 may obtain event and bet information. The event information and bet information may be obtained by communicating with the third device 300 and/or the fourth device 400.

At S420, similarly to S220, the second device 200 may send the bet information and the event information to the first device 100. At S430, similarly to S230, the second device 200 may receive the bet and bet conditions from the first device 100. At S432, the second device may receive a commission from the user account. This is an optional feature that may be charged by the bookmaker. Additionally, the bookmaker may charge a monitoring fee for the option of placing the conditional wager. Regardless of whether the conditions of the wager are met or not, the bookmaker would retain the monitoring fee. At S434, the system may optionally send information such as wager type, wager size, or other data to a data pool wherein bookmakers or other entities may analyze and utilize said data. At S436, a wager medium may be placed on hold in the user account.

At S440, the second device 200 may add the conditional wager to a conditional wager queue wherein the queue positions alike conditional wagers based upon the chronological order that the alike bets are placed. For example, if a first user places a conditional wager for the Bears +5 at 2:30 pm and a second user places a conditional wager for the Bears +5 at 2:31 pm, the first user's wager will be positioned higher in the conditional wager queue.

At S450, the second device 200 may monitor for bet conditions. The second device 200 may receive event information (current time, score, statistics, etc. for the event) from the third device 300 or the fourth device 400. The second device 200 may also receive bet information (current odds, spread, etc.) from the fourth device (not shown) and/or generate the bet information. The second device 200 may monitor this information so a determination can be made as to whether the bet conditions have been met.

At S452, the second device 200 may determine if the bet conditions have been met. For example, in the example given above, the second device 200 may check the event information and bet information to determine if the spread is at least Bears +5. If the bet condition has been met, the second device 200 may proceed to S460. If at least one of the bet conditions have not been met, the second device 200 may proceed to S454.

At S454, the second device 200 may determine if an end condition has been met. An end condition may be a condition that can never be true, or the end of the event, or other similar condition that makes it so the bet will not be placed. Alternatively, if a conditional wager has been filled, an end condition may constitution the determination of a win, push, or loss. For example, the user may create a conditional wager wherein the spread must be at least Bears +5, and the spread must become at least Bears +5 by the end of the first quarter. If the spread never reaches at least Bears +5 before the end of the first quarter, the system would proceed to S456, as the expiration of the first quarter would constitute an end condition. Alternatively, the second device 200 may send a message to the first device 100 that an end condition has been met and then end. If an end condition has not been met, the second device 200 may return to S452 and at the next time the event information or bet information is updated may again check to see if the bet conditions have been met.

At S460, beginning with a first chronologically placed conditional wager, the conditional wager queue may begin filling conditional bets. The conditional wager queue may not fill every bet within the queue. For example, if five users placed conditional bets for the Bears +5 and the Bears +5 condition is met, the queue may only fill the first chronologically placed conditional wager and move the spread to +4.5. In this example, if the spread again moves to +5, the second conditional wager, which was not filled the first time the spread reached +5, would now be the first in line to get filled. Determining how many bets from the queue are filled may depend on various factors such as predetermined odds movement formulations, wager volume, significant in game scenarios, etc.

Additionally, the conditional wager queue may operate as to fill in a price-first-timesecond manner. For example, if there are five conditional wagers in the queue for Bears +5, three conditional wagers in the queue for Bears +5.5, and four conditional wagers in the queue for Bears +6, orders will be filled in that order. In this example, if the game line jumps from +4.5 to +6, the first bets to fill would be the conditional wagers in the queue having Bears +5. These bets would be placed based upon chronological order as described above. In this example, given that the spread moved 1.5 points, these conditional bets may be filled at +5 or at +6, depending on the terms desired by the bookmaker. Next, conditional wagers having Bears +5.5 would be filled, followed by those having Bears +6.

At S462, if the conditional wager is filled, the system at S470 may take the predetermined wager amount from a user account. Alternatively, the wager amount may be paid by the user at S430. Furthermore, at S470, similarly to S432, the bookmaker may take an optional commission from the user account. If the conditional wager is not filled by the conditional wager queue at S464, the conditional wager may remain in the queue where it may or may not be filled if the conditions are again met. At S468, if a wager is in the queue and the event ends, the bet is cancelled. The conditional wager will continuously be monitored for conditions at S450.

At S480, the second device may monitor the event for win conditions. At S482, the system recognizes that the conditions have been met. Meeting said conditions for the filled conditional bet may include a push or tie, a win, or a voiding event. At S484, if event conditions meet a winning criteria, winnings from the conditionally filled wager are transferred to a user account, which may end the system at S488. Similarly, at S490, if the event conditions meet the criteria of a push or a tie, the original wager amount may be returned to the user's account, which may end the system at S492.

The conditional wager queue of the present invention may be particularly important for wagering on events that have already began, known as “live betting.” When wagering before an event has started, it is feasible to monitor changing odds with relatively sound accuracy, as wager volume and significant factors are stable. This is not the case once an event has started. The flow of factors including wagering flow and significant plays can cause excessive volatility in the prices and lines. Due to this, it is not possible to monitor changing lines during an event (much less multiple events simultaneously) with the accuracy necessary to obtain the desired price, unless wagers are placed with said predetermined conditions aligned with the queue of the present invention.

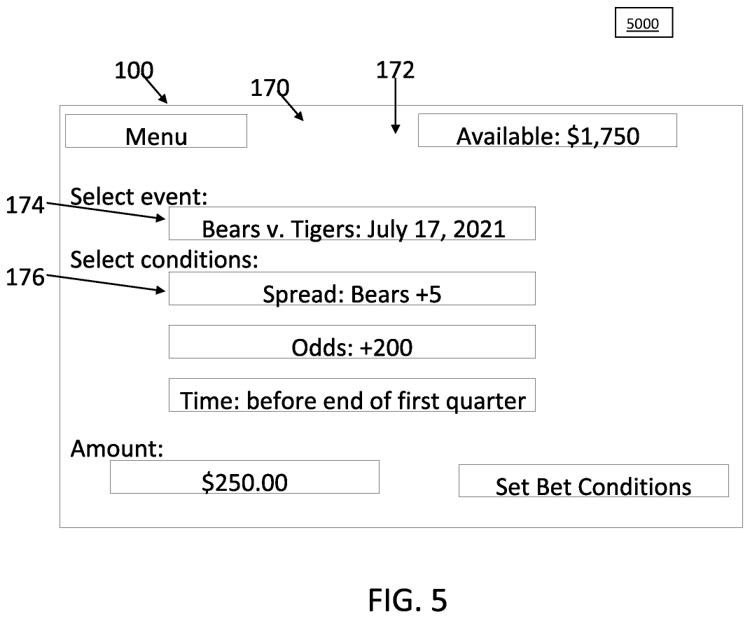

FIG. 5 shows an example view of a display 170 of the first device 100. The display 170 may display input information 172 that is input into a website, application, or other program. The input information 172 may include the bet and the bet conditions. For example, the input information 172 may include the event of the Bears v. Tigers on Jul. 17, 2021, with the wager amount of $250, and the bet conditions of Spread: Bears +5, Odds: +200; and Time: before the end of the first quarter. The user may be able to select the bet (including the event and bet amount) and the bet conditions using the first device 100 and send the bet and the bet conditions to the second device 200 so that the bet may be placed if the bet conditions are met during the event. The bet amount may be limited based on an amount in a digital wallet or other form of verified account such that a user cannot bet more than is available to the user. The user may also be limited based on local regulations. The user may be able to set bet conditions for several events, and even different bets and bet conditions on the same event.

Advantageously, by setting conditions for bets ahead of time, the user can get bets with the desired conditions without having to directly monitor the progress of the event. Furthermore, the user can set up conditions on several events that are running concurrently and get bets with favorable conditions in a number of events that would be impossible for any person attempting to monitor. Furthermore, electronic devices are much faster than people at determining if simple conditions (such as Boolean conditions) are met. Accordingly, the second device 200 may place a bet much faster when the conditions are met than a person could. This ensures (or at least greatly increases the likelihood) that the bet is placed with the proper conditions being met and that the conditions have not changed in the time between recognizing that the conditions have been met and placing the bet (betting odds can change very quickly because the betting odds may be based on the bets being placed on the event in real time).

Accordingly, the present description provides for various embodiments for a device or system for programming bets on an event to be made if conditions are met during the event. Many uses and advantages are offered by the device or system as described above in one or more non-limiting embodiments in the present description.

The corresponding structures, materials, acts, and equivalents of any means or step plus function elements in the claims below are intended to include any structure, material, or act for performing the function in combination with other claimed elements as specifically claimed. The description of the present invention has been presented for purposes of illustration and description but is not intended to be exhaustive or limited to the invention in the form disclosed. Many modifications and variations will be apparent to those of ordinary skill in the art without departing from the scope and spirit of the invention.

The embodiments were chosen and described in order to best explain the principles of the invention and the practical application, and to enable others of ordinary skill in the art to understand the invention for various embodiments with various modifications as are suited to the particular use contemplated. The present invention, according to one or more embodiments described in the present description, may be practiced with modification and alteration within the spirit and scope of the appended claims. Thus, the description is to be regarded as illustrative instead of restrictive of the present invention.

What is claimed is:

1. A host device comprising:
at least one memory including processor readable instructions; and
at least one processor arranged to read and execute the processor readable instructions stored on the at least one memory and execute the processor readable instructions to:
obtain event information and bet information, wherein the event information includes participants in an event and timing of the event, and wherein the bet information includes current odds for placing a bet on an event;
send event information and bet information to a user device;
receive a bet and bet conditions from the first device, wherein the bet is for a result of the event and the bet conditions are conditions for the bet to be placed on the result of the event;
monitor for bet conditions by monitoring event information and bet information; and
in response to the bet conditions being met, place the bet.

2. The host device of claim 1, wherein the processor is further arranged to read and execute the processor readable instructions stored on the at least one memory and execute the processor readable instructions to:
monitor the event information for win conditions, win conditions being part of the bet; and
in response to the bet conditions being met, transferring winnings to an account associated with the user.

3. The host device of claim 1, wherein the processor is further arranged to read and execute the processor readable instructions stored on the at least one memory and execute the processor readable instructions to:
place the bet into a conditional wager queue wherein alike bet conditions are chronologically ordered wherein upon the bet conditions being met, at least one bet condition from the conditional wager queue is place.

4. The host device of claim 1, wherein the bet is placed by sending a request to a bookmaking device, and the processor is further arranged to read and execute the processor readable instructions stored on the at least one memory and execute the processor readable instructions to:
receive bet results from the bookmaking device, wherein the bet results are the result of the bet; and send bet results to the user device.

5. A wagering system comprising:
a first device, a second device, and a conditional wager queue wherein:
the first device is configured to receive at least a bet information from the second device and send a wager condition to the second device; and the second device is configured to send the at least one bet information to the first device, receive the wager condition from the first device, add the wager condition to the conditional wager queue, monitor a at least one event for a at least one placement condition, fill at least one wager condition from the conditional wager queue in chronological order upon the occurrence of said placement condition, and monitor at least one event for at least a end condition.

6. The wagering system of claim 5, wherein the first device sends at least a wager medium to the second device.

7. The wagering system of claim 5, wherein the second device sends at least a return medium to the first device upon the occurrence of at least one end condition.

8. The conditional wager queue of claim 5 further comprising, a cutoff determination wherein upon reaching the cutoff determination, the conditional wager queue stops chronologically filling wager conditions and leaves unfilled wager conditions in the conditional wager queue.

9. The conditional wager queue of claim 8, wherein the reoccurrence of the at least one placement condition prompts the second device to fill at least one wager condition from the conditional wager queue in chronological order.

10. The wagering system of claim 5, further comprising a data pool wherein at least a conditional wager information is stored.

11. The wagering system of claim 5, wherein said wager condition involves an event that has commenced.

12. The wagering system of claim 5, wherein said wager conditions include at least a extra-event condition.

13. The wagering system of claim 5, wherein the conditional wager queue utilizes a price-first time-second configuration to fill conditional wagers.

14. The conditional wager queue of claim 13, further comprising at least a wager limitation wherein bet information changes can be avoided.

15. A wagering method comprising:
placing a conditional wager wherein the conditional wager is inputted by a user to a bookmaker and the conditional wager is chronologically placed into a conditional wager queue based upon a at least one condition; monitoring a at least one event for a placement condition by the bookmaker; activating the conditional wager queue when at least one placement condition from the at least one event occurs; filling at least one conditional wager from the conditional wager queue; and
ending the at least one filled conditional wager when an end condition is met.

16. The method of claim 15, wherein activating the conditional wager queue further comprises:
closing the conditional wager queue upon reaching a cutoff determination point wherein the conditional wager queue stops chronologically filling wager conditions and leaves unfilled conditional wagers in the conditional wager queue.

17. The method of claim 15, wherein activating the conditional wager queue further comprises:
utilizing a price-first-time-second configuration to fill conditional wagers.

18. The method of claim 15, wherein ending filled wagers when an end condition is met further comprises: the bookmaker transferring a wager medium to the user.
